(19) United States
(12) Patent Application Publication
(10) Pub. No.: US 2003/0166483 A1
(43) Pub. Date: Sep. 4, 2003

(54) Use of 3-iodine-2-propinyl-carbamates as antimicrobial active agent

(76) Inventor: Michael Heinzel, Bonn (DE)

Correspondence Address: HENKEL CORPORATION, 2500 RENAISSANCE BLVD, STE 200, GULPH MILLS, PA, 19406, US

(21) Appl. No.: 10/240,626

(22) PCT Filed: Mar. 30, 2001
(86) PCT No.: PCT/EP01/03629

(51) Int. Cl. C11D 1/00

(52) U.S. Cl. 510/220; 510/235; 510/382; 510/499

(57) ABSTRACT

The invention relates to the use of 3-iodine-2-propinyl-carbamates as antimicrobial, especially antimycotic, active agents in washing agents, cleaning agents, hand washing agents, hand washing-up liquids, washing-up liquids for dishwashers and agents for finishing textiles, furs or leather.

### DESCRIPTION

This invention relates to the use of 3-iodo-2-propinyl carbamates as antimicrobial agents, more particularly antimycotic agents, in detergents, cleaners, hand washing preparations, manual dishwashing detergents, machine dishwashing detergents and in preparations for the finishing of textiles, hides, skins or leather.

Hygiene in the context of washing and cleaning means not only the removal of visible soils, but also the destruction of germs which have contaminated the material to be cleaned, for example laundry, in use. Such germs are viruses and bacteria, but especially fungi. Accordingly, particular significance attaches to hygiene, particularly laundry hygiene, in the institutional sector where textiles from hospitals, hotels, guesthouses, etc., which do not circulate within a certain circle of users, but are used by many different users, are laundered. However, hygiene is also acquiring increasing significance in the home, above all because textiles worn directly on the body, such as underwear, sheer lingerie or stockings, are increasingly being made from fabrics which will not withstand washing temperatures of 40° C. or higher, proteases and bleaching agents, so that light-duty detergents with very little germicidal activity have to be used. For ecological reasons—not least because of the obligation on the part of industry to reduce energy consumption—washing processes are being increasingly minimized in their hygiene-active parameters (temperature, washing times and liquor ratio).

In the final analysis, the effect of all these factors together can be that germs which have contaminated laundry in wear are no longer sufficiently destroyed in the washing process and subsequently lead to hygiene problems during re-use. In addition, washing and dishwashing machines, above all those which have not been used for some time, can also lead to hygiene problems and to unpleasant odor emissions as a result of intensive germ growth in hoses, the pump or the dispensing compartment. If damp laundry remains in the washing machine for a prolonged period, it can become moldy and develop mold stains.

2-(3-Iodo-2-propinyloxy)-ethyl carbamates and their use for preserving technical products (for example paints, glues, dispersions, cooling lubricants), for the antimicrobial finishing of joint sealing compounds, for controlling mildew on walls, ceilings or wood floors, for the antimicrobial finishing of plastics, for example PVC films, and as preservatives for cosmetics are known from EP-B-0 093 962.

3-Iodo-2-propinyl butyl carbamate (IPBC) is known as a preservative from Appendix 6 of the Kosmetik Verordnung (“Cosmetics Directive”).

Applicants' hitherto unpublished DE-A-199 19 770.9 mentions the use of nanoscale IPBC as an antimicrobial agent in oral and/or dental care.

Applicants' hitherto unpublished DE-A-199 19 769:5 mentions the use of nanoscale IPBC as an antimicrobial agent in body deodorants.

The problem addressed by the present invention was to provide preparations with an antimicrobial effect and, more particularly an antimycotic effect which would be capable of overcoming the above-mentioned disadvantages of the prior art.

It has surprisingly been found that 3-iodo-2-propinyl carbamates, more particularly IPBC, show antimicrobial activity and, more particularly, antimycotic activity, even as a constituent of detergents and cleaning compositions. This discovery was particularly surprising because the uses of 2-(3-iodo-2-propinyloxy)-ethyl carbamates and IPBC known from the prior art suggested that the active substance has to remain permanently in the product to be preserved or antimicrobially finished.

Accordingly, the present invention relates to the use of 3-iodo-2-propinyl carbamates corresponding to formula (I) as an antimicrobial and, more particularly, antimycotic agent in laundry detergents, cleaners, hand washing preparations, manual dishwashing detergents and machine dishwashing detergents and in textile, skin and leather finishing preparations.

The 3-iodo-2-propinyl carbamates usable in accordance with the invention correspond to general formula (I):

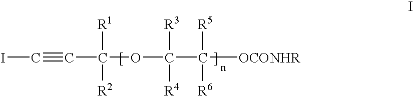

In which R¹ and R² may be the same or different and represent hydrogen, linear or branched C₁₋₆ alkyl groups,

R³, R⁴, R⁵ and R⁶ may be the same or different and represent hydrogen or C₁₋₄ alkyl groups,

R represents hydrogen or linear or branched C₁₋₂ alkyl groups or a cyclohexyl group, a phenyl group, a substituted phenyl group, a benzyl group or a p-toluenesulfonyl group and n=0 or 1.

According to the invention, a particularly preferred carbamate is IPBC which corresponds to formula I with R¹ and R²=hydrogen, n=0 and R=butyl (C₄H₉), more particularly n-butyl.

The compounds usable in accordance with the invention are prepared by methods known per se from the prior art, more particularly as described in EP-B-0 093 962 to which reference is hereby made in its entirety.

The 3-iodo-2-propinyl carbamates are prepared, for example, by reacting equimolar quantities of alcohols corresponding to general formula (II):

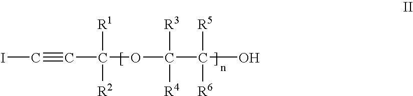

with suitable isocyanates corresponding to general formula (III):

OCN—R (III)

In formulae (II) and (III), the symbols R¹, R², R³, R⁴, R⁵, R⁶ and R and n have the same meanings as defined for formula (I). Examples of the linear or branched C₁₋₆ alkyl groups represented by R¹ and R² are methyl, ethyl, propyl, isopropyl, n-butyl, isobutyl, sec. butyl, tert. butyl, pentyl, hexyl and branched isomers thereof. Preferred compounds of formula (I) are those in which both substituents R¹ and R² are hydrogen or methyl and those in which one of the substituents R¹ and R² is hydrogen while the other is methyl.

Examples of the C₁₋₄ alkyl groups represented by R³, R⁴, R⁵ and R⁶ are methyl, ethyl, propyl, isopropyl, n-butyl, isobutyl, sec. butyl and tert. butyl, methyl being preferred.

Preferred compounds of general formula (I) are those in which at least four of the substituents R¹ to R⁶ represent hydrogen. Examples of the linear and branched C₁₋₁₂ alkyl groups represented by R are methyl, ethyl, propyl, isopropyl, n-butyl, isobutyl, sec. butyl, tert. butyl, pentyl, hexyl, heptyl, octyl, nonyl, decyl, undecyl, dodecyl and the branched isomers of C₅₋₁₂ alkyl groups. Examples of the substituted phenyl groups represented by R are chlorophenyl, bromophenyl, fluorophenyl, dichlorophenyl and trichlorophenyl. Preferred compounds are those in which R is a lower C₁₋₄ alkyl group or a phenyl group or a chlorine- or bromine-substituted phenyl group. Examples of particularly preferred compounds are those in which R is propyl, butyl or phenyl.

The N-substituted 3-iodo-2-propinyl carbamates corresponding to general formula (I) are synthesized by methods known per se (Houben-Weyl, Methoden der organischen Chemie, Vol. 8, pp. 141-144 (1952)) by reacting equimolar quantities of the alcohols corresponding to general formula (II) with suitable, for example commercially available, isocyanates corresponding to general formula (III). The reaction is carried out at temperatures of about 10° C. to about 70° C. and preferably at temperatures of about 20° C. to about 30° C.

The reactions are generally carried out in an inert solvent, for example ethylene chloride, dimethyl formamide, toluene, chlorobenzene, methylene chloride or tetrahydrofuran.

The reactions may be accelerated by catalysts. Such catalysts as dibutyl tin dilaurate have proved to be suitable. Other catalysts which may be used are dibutyl tin diacetate and tert. bases, such as triethylamine.

The alcohols corresponding to general formula (II) may be prepared by methods known per se by iodizing propargyl alcohol or substituted propargyl alcohols (n=0) or in two reaction stages by reacting propargyl alcohol or substituted propargyl alcohols with ethylene oxide or substituted epoxides and then iodizing the propinyloxy alcohols obtained (n=1). Examples of alcohols corresponding to general formula (II) are 3-iodo-2-propinol, 2-(3-iodo-2-propinyloxy)-ethanol, 2-(4-iodo-3-butin-2-yloxy)-ethanol, 1-(3-iodo-2-propinyloxy)-2-propanol and 1-(2-hydroxyethoxy)-1-iodoethinyl cyclohexane.

Examples of isocyanates are methyl isocyanate, ethyl isocyanate, propyl isocyanate, butyl isocyanate, phenyl isocyanate, 4-chlorophenyl isocyanate, cyclohexyl isocyanate, 4-fluorophenyl isocyanate, 3,4-dichlorophenyl isocyanate, 2,4,5-trichlorophenyl isocyanate and p-toluenesulfonyl isocyanate.

The 3-iodo-2-propinyl carbamates usable in accordance with the invention are added in known manner to the liquid compositions in which they are intended to develop their effect. For use in solid compositions, the 3-iodo-2-propinyl carbamates usable in accordance with the invention may either be added to the liquid or paste-form starting materials from which the solid compositions are produced or, alternatively, may be applied to the solid compositions, for example by spraying.

The 3-iodo-2-propinyl carbamates usable in accordance with the invention are preferably added to the laundry detergents, cleaning compositions, hand washing compositions, manual dishwashing detergents, machine dishwashing detergents and preparations for finishing textiles, hides, skins or leather in an organic solvent, more particularly an alcohol, preferably ethanol.

In another preferred embodiment, the 3-iodo-2-propinyl carbamates usable in accordance with the invention are added to the above-mentioned compositions in nanoscale form. Nanoscale substances in the context of the invention are substances of which the particle diameter in the direction of the largest dimension of the particles is less than 1,000 nm (nanometers). In one particular embodiment, the particle diameter of the 3-iodo-2-propinyl carbamates usable in accordance with the invention is about 5 to 500 nm and preferably 10 to 150 nm. In the present specification, the term “nanoparticulate” is also used synonymously with the term “nanoscale”.

The nanoscale active substances usable in accordance with the invention consist of a discrete phase of the active substance onto the surface of which preferably at least one surface modifier is adsorbed. Particularly suitable surface modifiers are emulsifiers and/or protective colloids. The effect of coating the particles with emulsifiers and/or protective colloids is that it prevents subsequent agglomeration of the particles.

Suitable emulsifiers are, for example, nonionic surfactants from at least one of the following groups:

(1) products of the addition of 2 to 30 moles of ethylene oxide and/or 0 to 5 moles of propylene oxide onto linear fatty alcohols containing 8 to 22 carbon atoms, onto fatty acids containing 12 to 22 carbon atoms and onto alkylphenols containing 8 to 15 carbon atoms in the alkyl group;

(2) C_{12/18} fatty acid monoesters and diesters of products of the addition of 1 to 30 moles of ethylene oxide onto glycerol;

(3) glycerol monoesters and diesters and sorbitan monoesters and diesters of saturated and unsaturated fatty acids containing 6 to 22 carbon atoms and ethylene oxide adducts thereof;

(4) alkyl mono- and oligoglycosides containing 8 to 22 carbon atoms in the alkyl group and ethoxylated analogs thereof;

(5) products of the addition of 15 to 60 moles of ethylene oxide onto castor oil and/or hydrogenated castor oil;

(6) polyol esters and, in particular, polyglycerol esters such as, for example, polyglycerol polyricinoleate, polyglycerol poly-12-hydroxy-stearate or polyglycerol dimerate isostearate. Mixtures of compounds from several of these classes are also suitable;

(7) products of the addition of 2 to 15 moles of ethylene oxide onto castor oil and/or hydrogenated castor oil;

(8) partial esters based on linear, branched, unsaturated or saturated C_{6/22} fatty acids, ricinoleic acid and 12-hydroxystearic acid and glycerol, polyglycerol, pentaerythritol, dipentaerythritol, sugar alcohols (for example sorbitol), alkyl glucosides (for example methyl glucoside, butyl glucoside, lauryl glucoside) and polyglucosides (for example cellulose);

(9) mono-, di and trialkyl phosphates and mono-, di- and/or tri-PEG-alkyl phosphates and salts thereof;

(10) wool wax alcohols;

(11) polysiloxane/polyalkyl polyether copolymers and corresponding derivatives;

(12) mixed esters of pentaerythritol, fatty acids, citric acid and fatty alcohol according to DE 1165574 PS and/or mixed esters of fatty acids containing 6 to 22 carbon atoms, methyl glucose and polyols, preferably glycerol or polyglycerol, and

(13) polyalkylene glycols.

The addition products of ethylene oxide and/or propylene oxide onto fatty alcohols, fatty acids, alkylphenols, glycerol monoesters and diesters and sorbitan monoesters and diesters of fatty acids or onto castor oil are known, commercially available products. They are homolog mixtures of which the average degree of alkoxylation corresponds to the ratio between the quantities of ethylene oxide and/or propylene oxide and substrate with which the addition reaction is carried out. C_{12/18} fatty acid monoesters and diesters of addition products of ethylene oxide onto glycerol are known as refatting agents for cosmetic formulations from DE-PS 20 24 051.

C_{8/18} alkyl mono- and oligoglycosides, their production and their use as surfactants are known from the prior art. They are produced in particular by reaction of glucose or oligosaccharides with primary alcohols containing 8 to 18 C atoms. So far as the glycoside component is concerned, both monoglycosides, in which a cyclic sugar unit is attached to the fatty alcohol by a glycoside linkage, and oligomeric glycosides with a degree of oligomerization of preferably up to about 8 are suitable. The degree of oligomerization is a statistical mean value on which a homolog distribution typical of such technical products is based.

Typical examples of anionic emulsifiers are soaps, alkyl benzenesulfonates, alkanesulfonates, olefin sulfonates, alkylether sulfonates, glycerol ether sulfonates, i-methyl ester sulfonates, sulfofatty acids, alkylsulfates, fatty alcohol ether sulfates, glycerol ether sulfates, hydroxy mixed ether sulfates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl(ether) phosphates. If the anionic surfactants contain polyglycol ether chains, they may have a conventional homolog distribution although they preferably have a narrow-range homolog distribution.

Zwitterionic surfactants may also be used as emulsifiers. Zwitterionic surfactants are surface-active compounds which contain at least one quaternary ammonium group and at least one carboxylate and one sulfonate group in the molecule. Particularly suitable zwitterionic surfactants are the so-called betaines, such as the N-alkyl-N,N-dimethyl ammonium glycinates, for example trimethyl ammonium glycinate, cocoalkyl dimethyl ammonium glycinate, N-acylaminopropyl-N,N-dimethyl ammonium glycinates, for example cocoacylaminopropyl dimethyl ammonium glycinate, and 2-alkyl-3-carboxymethyl-3-hydroxyethyl imidazolines containing 8 to 18 carbon atoms in the alkyl or acyl group and cocoacylaminoethyl hydroxyethyl carboxymethyl glycinate. The fatty acid amide derivative known by the CTFA name of Cocamidopropyl Betaine is particularly preferred.

Other suitable emulsifiers are ampholytic surfactants. Ampholytic surfactants are surface-active compounds which, in addition to a C_{8/18} alkyl or acyl group, contain at least one free amino group and at least one —COOH or —SO₃H group in the molecule and which are capable of forming inner salts. Examples of suitable ampholytic surfactants are N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids and alkyl-aminoacetic acids containing around 8 to 18 carbon atoms in the alkyl group. Particularly preferred ampholytic surfactants are N-cocoalkylaminopropionate, cocoacylaminoethyl aminopropionate and C_{12/18} acyl sarcosine. Besides ampholytic emulsifiers, quaternary emulsifiers may also be used, those of the esterquat type, preferably methyl-quaternized difatty acid triethanolamine ester salts, being particularly preferred. Typical examples of anionic emulsifiers are alkyl sulfates, alkylether sulfates and monoglyceride (ether) sulfates.

The active substances and the emulsifiers are used in a ratio by weight of generally 1:100 to 100:1, preferably 1:25 to 25:1 and more particularly 1:10 to 10:1. Emulsifiers capable of forming microemulsions are particularly preferred.

Suitable protective colloids are, for example, gelatin, casein, gum arabic, lysalbinic acid, starch, carboxymethyl cellulose or modified carboxymethyl cellulose and polymers such as, for example, polyvinyl alcohols, polyvinyl pyrrolidones, polyalkylene glycols and polyacrylates.

The 3-iodo-2-propinyl carbamates suitable for use in accordance with the invention may also be used in the form of nanoparticles coated with one or more emulsifiers and/or protective colloids.

Corresponding nanoparticles may be produced, for example, by

(a) introducing 3-iodo-2-propinyl carbamates into a liquid phase in which they are insoluble,

(b) heating the resulting mixture beyond the melting point of the 3-iodo-2-propinyl carbamates,

(c) adding an effective quantity of at least one emulsifier to the resulting oil phase and finally

(d) cooling the emulsion below the melting point of the 3-iodo-2-propinyl carbamates.

Another process for the production of nanoparticles by rapid expansion of supercritical solutions (RESS process) is known, for example, from the article by S. Chihlar, M. Türk and K. Schaber in Proceedings World Congress on Particle Technology 3, Brighton, 1998. To prevent the nanoparticles from re-agglomerating, it is advisable to dissolve the starting materials in the presence of suitable protective colloids or emulsifiers and/or to expand the critical solutions into aqueous and/or alcoholic solutions of the protective colloids or emulsifiers or into cosmetic oils which may in turn contain redissolved emulsifiers and/or protective colloids. Another suitable process for the production of nanoscale particles is the evaporation technique. Here, the starting materials are dissolved in a suitable organic solvent (for example alkanes, vegetable oils, ethers, esters, ketones, acetals and the like). The resulting solutions are then introduced into water or another nonsolvent—generally in the presence of a surface-active compound dissolved therein—so that the homogenization of the two immiscible solvents results in precipitation of the nanoparticles, the organic solvent preferably evaporating. O/w emulsions or o/w microemulsions may be used instead of an aqueous solution. The emulsifiers and protective colloids mentioned at the beginning may be used as the surface-active compounds. Another method for the production of nanoparticles is the so-called GAS process (gas anti-solvent recrystallization). This process uses a highly compressed gas or supercritical fluid (for example carbon dioxide) as non-solvent for the crystallization of dissolved substances. The compressed gas phase is introduced into the primary solution of the starting materials and absorbed therein so that there is an increase in the liquid volume and a reduction in solubility and fine particles are precipitated. The PCA process (precipitation with a compressed fluid anti-solvent) is equally suitable. In this process, the primary solution of the starting materials is introduced into a supercritical fluid which results in the formation of very fine droplets in which diffusion processes take place so that very fine particles are precipitated. In the PGSS process (particles from gas saturated solutions), the starting materials are melted by the introduction of gas under pressure (for example carbon dioxide or propane). Temperature and pressure reach near- or super-critical conditions. The gas phase dissolves in the solid and lowers the melting temperature, the viscosity and the surface tension. On expansion through a nozzle, very fine particles are formed as a result of cooling effects.

The above-described production processes for the nanoparticles according to the invention are merely mentioned as examples and are not intended to limit the scope of the invention in any way.

The concentration of the 3-iodo-2-propinyl carbamates usable in accordance with the invention in the compositions may be varied over a wide range depending on the conditions under which the compositions are used. The quantity in which the dissolved or nanoscale 3-iodo-2-propinyl carbamates is used is selected so that the concentration of the 3-iodo-2-propinyl carbamates is normally of the order of 0.001 to 5, preferably 0.01 to 2 and more particularly 0.1 to 1% by weight, based on the preparations.

The present invention also relates to laundry detergents, cleaning compositions, rinse agents, hand washing compositions, manual dishwashing detergents, machine dishwashing detergents and preparations for finishing textiles, hides, skins or leather which contain a 3-iodo-2-propinyl carbamate corresponding to formula (I) or several 3-iodo-2-propinyl carbamates, more particularly those which contain IPBC. In a preferred embodiment, the invention relates to laundry detergents, cleaning compositions, rinse agents, hand washing compositions, manual dishwashing detergents, machine dishwashing detergents and preparations for finishing textiles, hides, skins or leather to which 3-iodo-2-propinyl carbamates, more particularly IPBC, are added in nanoparticulate form.

The present invention also relates to the use of 3-iodo-2-propinyl carbamates corresponding to formula I, more particularly IPBC, as antimicrobial and more particularly antimycotic agents in preparations for the antimicrobial finishing of textiles, hides, skins or leather.

The present invention also relates to textiles, hides, skins or leather finished with an agent according to the invention.

The textiles, hides, skins or leather are finished in known manner, for example by immersing the textiles, hides, skins or leather in a suitably concentrated solution of an agent according to the invention.

The following Examples are intended to illustrate the invention without limiting it in any way.

1.1. Test substances

Because of its poor solubility in water, IPBC (30% in dipropylene glycol) obtained from Milker & Grüning GmbH, Horhausen, was pre-diluted as follows:

An alcoholic stock solution containing 1% active substance was prepared by weighing 3.34 g 30% IPBC into 100 ml 99% ethanol and then further diluted with twice-distilled water to form the required test solutions, namely:

2 ml stock solution ad 200 ml twice-dist. H₂O→100 ppm IPBC (=0.99% ethanol)

10 ml stock solution ad 200 ml twice-dist. H₂O→500 ppm IPBC (=4.95% ethanol)

15 ml stock solution ad 200 ml twice-dist. H₂O→750 ppm IPBC (=7.42% ethanol)

An antibacterial and antimycotic formulation containing 70% by weight didecyl dimethyl ammonium chloride, 15% by weight ethylene glycol, balance water, was used as a reference preparation. The reference preparation was also diluted with twice-distilled water.

1.2. Test fungi

Candida albicans, ATCC 10231 (precultured on CaSo agar, 4 d/25° C.), Aspergillus niger, ATCC 6275 (precultured on malt agar, 8d/25° C.), Trichophyton mentagrophytes, ATCC 9533 (precultured on malt agar, 8d/25° C.), Cladosporium cladosporioides, DSM 62121 (precultured on malt agar, 8d/25° C.), Epicoccum nigrum, self-isolate (precultured on malt agar, 8d/25°).

The inocula were obtained by floating off the preculture plates with 0.05% Tween®80 and had the following germ contents:

| | |
|---|---|
| Canidida albicans | 1.9 × 10⁹ CFU/ml |
| Aspergillus niger | 1.0 × 10⁷ CFU/ml |
| Trichophyton mentagrohpytes | 5.0 × 10⁷ CFU/ml |
| Cladosporium cladosporioides | 5.0 × 10⁷ CFU/ml |
| Epicoccum nigrum | 1.9 × 10⁵ CFU/ml |

(CFU = colony forming units)

1.3. Testing of fungistatic activity by the inhibition test

1×1 cm prewashed and autoclaved test specimens of standard cotton cloth to DIN 53919 (WfK-Testgewebe GmbH, Adlerstr. 42, Krefeld) were placed in the test solutions for 15 minutes, removed under sterile conditions and dried for 14 h at room temperature. 0.1 ml inoculation suspensions of the test fungi mentioned above were inoculated into malt agar in a petri dish and, after the agar had solidified, 0.1 ml was spread over the agar surface with a spatula.

The test specimens impregnated with the test solutions were then placed on the agar surface under sterile conditions and the dishes were incubated for 7 days at 25° C. The inhibiting effect was then evaluated to the following scheme:

0=distinct inhibition halo, inhibition zone expressed in mm

1=no growth on the test specimen, but no inhibition halo either

2=isolated growth on the test specimen

3=moderate growth on the test specimen

4=uninhibited growth on the test specimen

1.4. Testing of fungicidal activity by the DGHM germ carrier test

The test was carried out under the Richtlinien für die Prüfung und Bewertung chemischer Desinfektionsverfahren (Guidelines for the Testing and Evaluation of Chemical Disinfection Processes) of the Deutsche Gesellschaft für Hygiene und Mikrobiologie (DGHM), Gustav Fischer Verlag, 1981:

16 prewashed and autoclaved test specimens were placed in the above-mentioned inoculation suspensions of the test fungi and left therein for 15 minutes during which they were turned over several times. The test specimens thus contaminated were then transferred to empty Petri dishes where 10 ml of the test solutions were poured over them. After contact times of 60 and 120 minutes at 20° C., two of the test specimens were removed, briefly transferred to 10 ml of DGHM inactivator solution and then inoculated onto CaSo plates (Candida) or malt agar plates (other test fungi). Incubation lasted 7 days at 25° C. and was followed by qualitative evaluation, i.e. growth yes (+) or no (−).

2. Results

2.1. Fungistatic activity of IPBC

2.1.1. The testing of the inhibiting activity of IPBC produced the following results:

| | | | | Twice- |
|---|---|---|---|---|
| Test fungus/ | 100 ppm | 500 ppm | 750 ppm | dist. |
| evaluation | IPBC | IPBC | IPBC | H₂O |
| Candida | 1/1 | 0/0 3-5 mm | 0/0 3-5 mm | 4/4 |
| albicans | | | | |
| Aspergillus | 0/0 3-5 mm | 0/0 9-11 mm | 0/0 10-12 mm | 4/4 |
| niger | | | | |
| Trichophyton | 0/0 3-6 mm | 0/0 12-15 mm | 0/0 15-18 mm | 4/4 |
| mentagrophytes | | | | |
| Cladosporium | 0/0 1 mm | 0/0 5-7 mm | 0/0 5-7 mm | 4/4 |
| cladosporioides | | | | |
| Epicoccum | 0/0 5-9 mm | 0/0 11-14 mm | 0/0 12-15 mm | 4/4 |
| nigrum | | | | |

2.1.3. For comparison, the fungistatic activity of the reference preparation (R):

| Test fungus/ | | | | Twice-dist. |
|---|---|---|---|---|
| Evaluation | 50 ppm R | 100 ppm R | 250 ppm R | H₂O |
| Candida albicans | 1/1 | 1/1 | 1/1 | 4/4 |
| Aspergillus niger | 4/4 | 4/4 | 4/4 | 4/4 |
| Trichophyton | 3/3 | 1/1 | 0/0 1 mm | 4/4 |
| mentagrophytes | | | | |
| Cladosporium | 4/4 | 2/2 | 0/0 1 mm | 4/4 |
| cladosporioides | | | | |
| Epicoccum | 2/2 | 2/2 | 0/0 2 mm | 4/4 |
| nigrum | | | | |

2.2 Fungicidal activity of IPBC

2.2.1. Testing of the fungicidal activity of IPBC produced the following results (+=living culture, −=dead culture):

| Test | | | | |
|---|---|---|---|---|
| fungus/ | 100 ppm | 500 ppm | 750 ppm | Twice-dist. |
| evaluation | IPBC | IPBC | IPBC | H₂O |
| Candida | 60 mins. + | 60 mins. + | 60 mins. + | 60 mins. + |
| albicans | 120 mins. + | 120 mins. + | 120 mins. + | 120 mins. + |
| Aspergillus | 60 mins. + | 60 mins. + | 60 mins. + | 60 mins. + |
| niger | 120 mins. + | 120 mins. + | 120 mins. + | 120 mins. + |
| Trichophyton | 60 mins. + | 60 mins. − | 60 mins. − | 60 mins. + |
| mentagrophytes | 120 mins. + | 120 mins. − | 120 mins. − | 120 mins. + |
| Cladosporium | 60 mins. + | 60 mins. − | 60 mins. − | 60 mins. + |
| cladosporioides | 120 mins. + | 120 mins. − | 120 mins. − | 120 mins. + |
| Epicoccum | 60 mins. + | 60 mins. − | 60 mins. − | 60 mins. + |
| nigrum | 120 mins. + | 120 mins. − | 120 mins. − | 120 mins. + |

2.2.3. The comparison test with the reference preparation revealed positive growth for all test fungi up to the highest test concentration of 250 ppm.

3. Result

By comparison with the reference preparation, IPBC shows very good fungistatic activity both against dermatophytes and against fungi producing mildew spots and material-damaging fungi.

1. The use of 3-iodo-2-propinyl carbamates corresponding to formula (I): 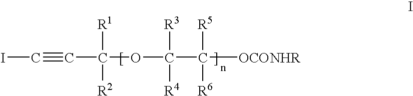
in which R¹ and R² may be the same or different and represent hydrogen, linear or branched C₁₋₆ alkyl groups,
R³, R⁴, R⁵ and R⁶ may be the same or different and represent hydrogen or C₁₋₄ alkyl groups,
R represents hydrogen, linear or branched C₁₋₁₂ alkyl groups or a cyclohexyl group, a phenyl group, a substituted phenyl group, a benzyl group or a p-toluenesulfonyl group and n=0 or 1,
as antimicrobial agents in laundry detergents, cleaners, rinse agents, hand washing preparations, manual dishwashing detergents and machine dishwashing detergents and in preparations for the antimicrobial finishing of textiles, hides, skins or leathers.

2. The use claimed in claim 1, characterized in that IPBC is used as the 3-iodo-2-propinyl carbamate.

3. The use claimed in claim 1 or 2, characterized in that the 3-iodo-2-propinyl carbamates are used in nanoparticulate form.

4. The use claimed in any of claims 1 to 3, characterized in that antimicrobial more particularly means antimycotic.

5. Laundry detergent containing one or more 3-iodo-2-propinyl carbamates, more particularly IPBC.

6. Cleaner containing one or more 3-iodo-2-propinyl carbamates, more particularly IPBC.

7. Rinse agent containing one or more 3-iodo-2-propinyl carbamates, more particularly IPBC.

8. Hand washing preparation containing one or more 3-iodo-2-propinyl carbamates, more particularly IPBC.

9. Manual dishwashing detergent containing one or more 3-iodo-2-propinyl carbamates, more particularly IPBC.

10. Machine dishwashing detergent containing one or more 3-iodo-2-propinyl carbamates, more particularly IPBC.

11. Preparation for finishing textiles, hides, skins or leather containing one or more 3-iodo-2-propinyl carbamates, more particularly IPBC.

12. Preparation as claimed in any of claims 5 to 11, characterized in that 3-iodo-2-propinyl carbamates, more particularly IPBC, in nanoparticulate form were added to them.

13. Textiles, hides, skins or leather finished with the preparation claimed in claim 11 or 12.
